(19) United States
(12) Patent Application Publication
(10) Pub. No.: US 2007/0119442 A1
(43) Pub. Date: May 31, 2007

(54) Portable cooking device

(76) Inventor: Wei-Teh Ho, Taipei (TW)

Correspondence Address: HDSL, 4331 STEVENS BATTLE LANE, FAIRFAX, VA, 22033, US

(21) Appl. No.: 11/288,221

(22) Filed: Nov. 29, 2005

(51) Int. Cl. A47J 37/07

(52) U.S. Cl. 126/9 R

(57) ABSTRACT

A portable cooking device includes a cooking platform and a set of cooking tools. The cooking platform has two symmetrically disposed cooking chambers; a heating tube is disposed in each chamber. Two pivotal elements are provided between the two chambers and two handles are provided on a top surface of the device. Whence, several cooking tools may be chosen from so as to be placed on either cooking chamber, and food may be placed on a cooking tool so as to be cooked by the heating tube. After cooking is finished, the two pivotal elements allow the cooking device to be folded and carried around.

### BACKGROUND OF THE INVENTION

1. Field of the Invention

The invention generally relates to a portable cooking device. More particularly, the invention relates to a portable cooking device that may be used to barbecue or cook steaks, beef, hotdogs, burgers and other kinds of food and that is easy to clean, environmentally friendly and economical.

2. Description of the Prior Art

In the contemporary society, with the fast development of urbanization, work and daily life become ever more stressful. People start to put more emphasis on their leisure activities and hope to use leisure activities to balance their life.

In the traditional barbecue activity, we have to prepare food, iron frame, charcoal, etc. If something goes wrong, such barbecue activity may be greatly affected and quarrels may occur between friends.

In addition, garbage and grease are generated in the traditional barbecue activity, and hence such activity pollutes our environment.

To eliminate the disadvantages of the prior art, the portable cooking device of the present invention is invented. The portable cooking device of the present invention is compact, easy to use, easy to carry around and environmentally friendly. It may be used in the outdoor and in our home. After the inventor put a lot of effort in the subject and conducted some experiments, the inventor has successfully come up with the portable cooking device of the present invention.

### SUMMARY OF THE INVENTION

The present invention is to provide a portable cooking device that is easy to use and has several cooking functions.

Another, the present invention is to provide a portable cooking device that is compact and easy to carry around so that it may be used in a recreational vehicle, an SUV and in our home,

Third, the present invention is to provide a portable cooking device that is environmentally friendly, easy to clean and allows grease to be gathered and discarded.

The portable cooking device of the present invention comprises a heating platform and a set of cooking tools. The heating platform has two symmetrically disposed cooking chambers; a heating tube is disposed in each chamber. A cooking tool may be placed at an upper portion of either chamber so that food placed on the tool may be cooked by the heating tube. Two pivotal elements are provided between the two chambers, and two handles are provided on a top surface of the device so that the cooking device may be folded and carried around. Several cooking tools may be chosen according to how a user wishes his food to be cooked. Also, grease may be gathered and discarded so as to be environmentally friendly.

### BRIEF DESCRIPTION OF THE DRAWINGS

FIG. 1 is a perspective view of the portable cooking device of the present invention, showing the cooking device in a partially open position.

FIG. 2 is a perspective view of the portable cooking device of the present invention, showing the cooking device in a closed position.

FIG. 3 is another perspective view of the portable cooking device of the present invention, showing the cooking device in a closed position.

FIG. 4 is a perspective view of the portable cooking device of the present invention, showing a cooking tool of the portable cooking device.

FIG. 5 is a perspective view of the portable cooking device of the present invention, showing two cooking tools of the portable cooking device.

FIG. 6 is a perspective view of the portable cooking device of the present invention, showing another cooking tool of the portable cooking device.

FIG. 6A is an exploded view showing the relative positions of several components of the barbecue unit of the portable cooking device.

FIG. 6B is a perspective view showing how the handle is connected with the barbecue unit.

FIG. 6C is a perspective view showing that a barbecue net unit is used with the barbecue unit.

FIG. 7 is a perspective view showing another cooking tool.

FIG. 8 is a perspective view showing yet another cooking tool.

### DETAILED DESCRIPTION OF THE PREFERRED EMBODIMENT

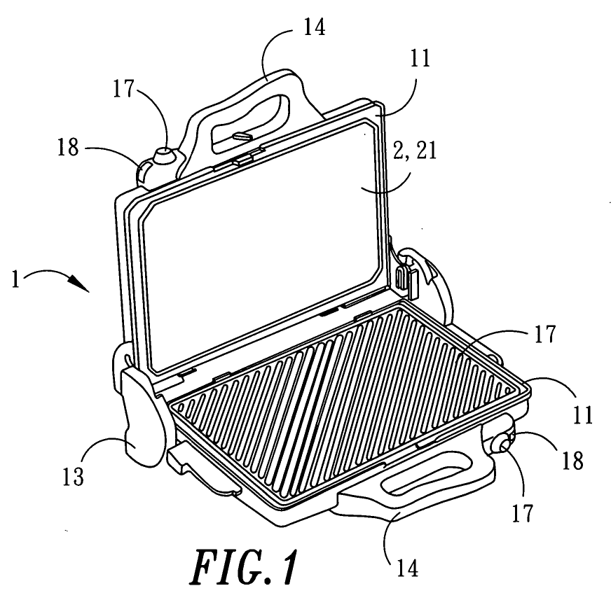

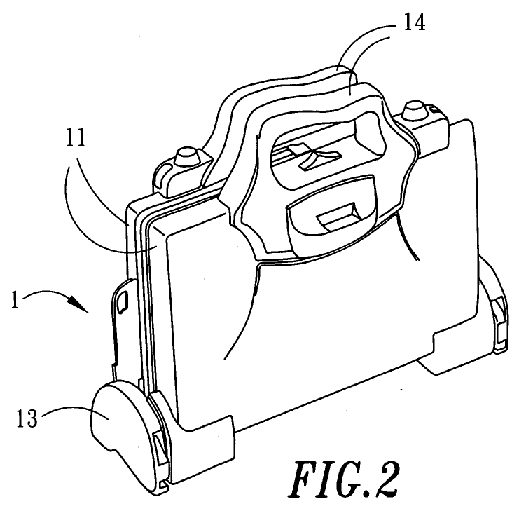

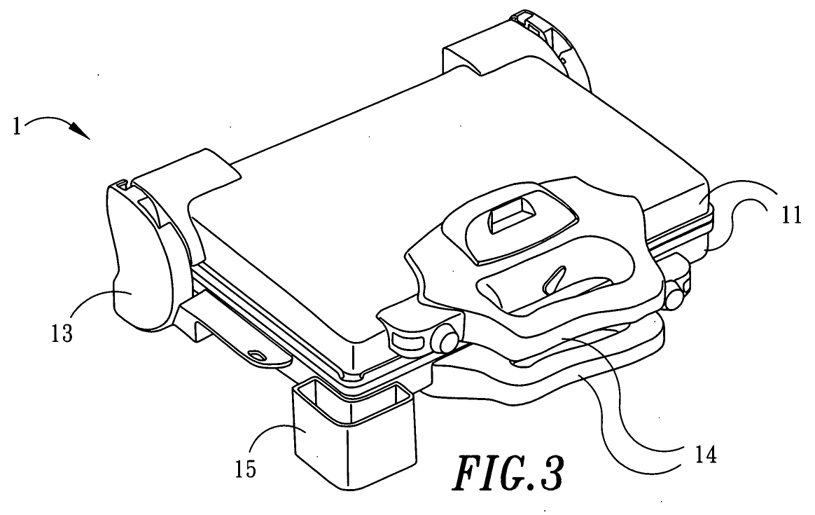

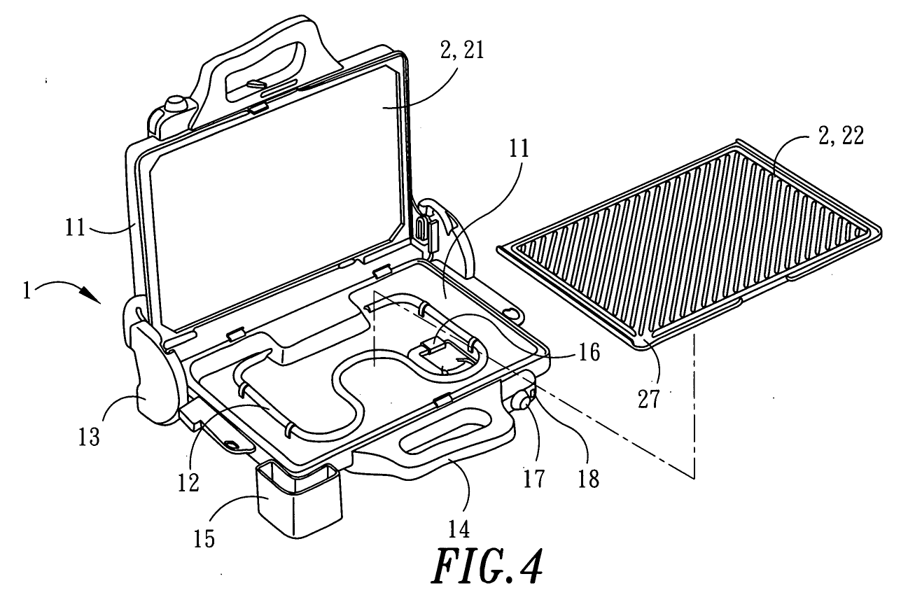

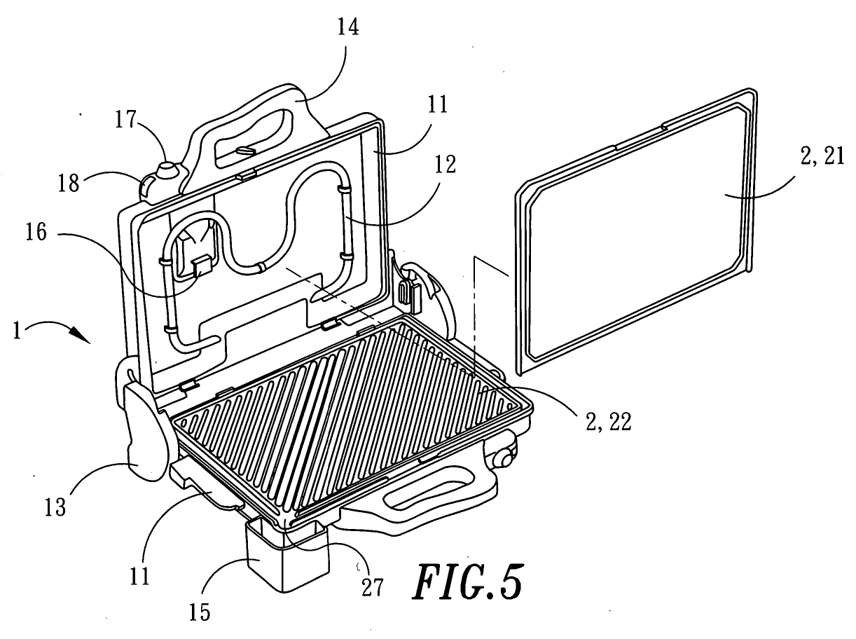

Please refer to FIG. 1 to 5. The portable cooking device of the present invention comprises a cooking platform 1 and a set of cooking tools 2. The heating platform 1 has two symmetrically disposed cooking chambers 11; a heating tube 12 is disposed in each chamber 11 so that either chamber 11 may be independently operated. A cooking tool 2 may be placed at an upper portion of either chamber 11 so that food placed on the tool 2 may be cooked by the heating tube 12. Two pivotal elements 13 are provided between the two chambers 11 and two handles 14 are provided on a top surface of the device so that the device may be folded and be carried around.

A grease collecting pan 15 may be fitted at a corner of either chamber 11. A grease guiding path 27 is provided at the corresponding corner of a cooking tool 2 so that grease generated by the food may flow to the grease collecting pan 15 via the grease guiding path 27.

A safety switch 16 is disposed by either heating tube 12. In use, after the cooking tool 2 is properly placed on either chamber 11, a user may then press the safety switch 16 to turn on the device. A control knob 17 is provided by either handle 14 and an indicator light 18 is provided by each knob 17. A user may use either control knob 17 to turn on and off the power and adjust the cooking temperature of the corresponding chamber 11. Also, when power is turned on, the indicator light 18 will be lit. Power is provided by a power source outside of the device; such electric design is quite ordinary and hence we will not elaborate on it.

Please refer to FIGS. 1, 4 and 5. The set of cooking tools 2 includes an several cooking tools, such as a plate 21 with a smooth top surface or a plate 22 with a top surface of linear pattern.

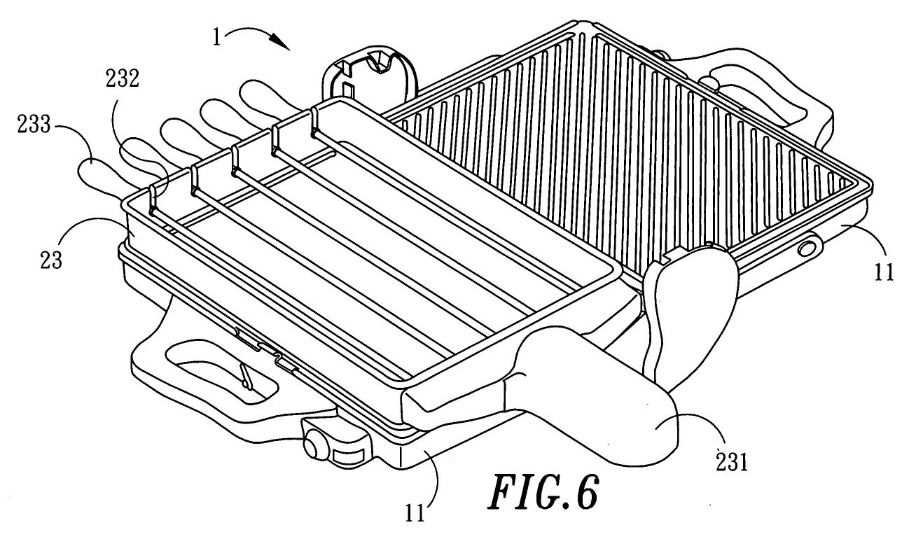

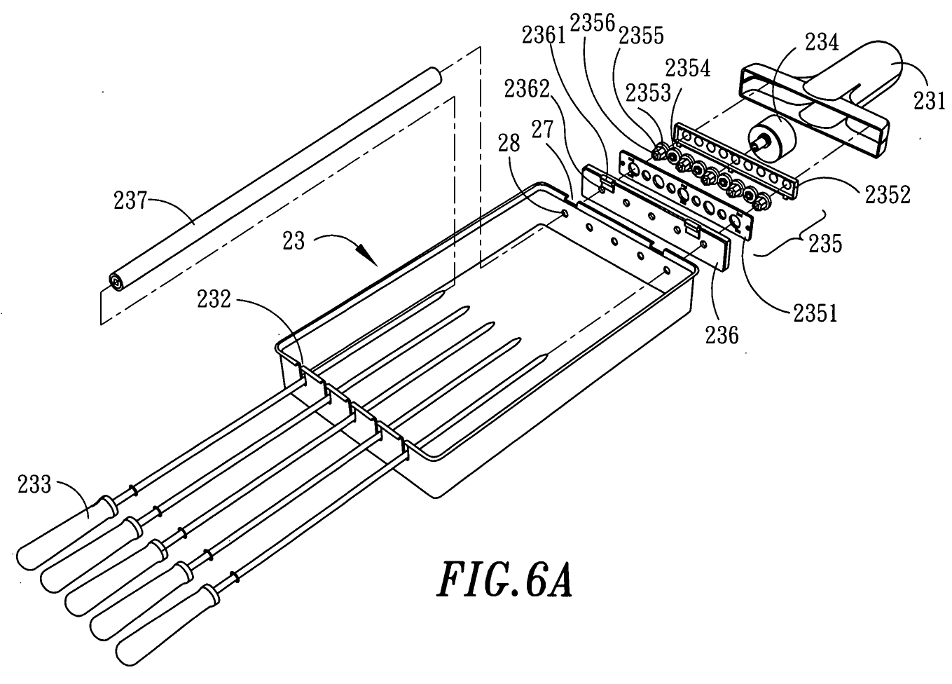

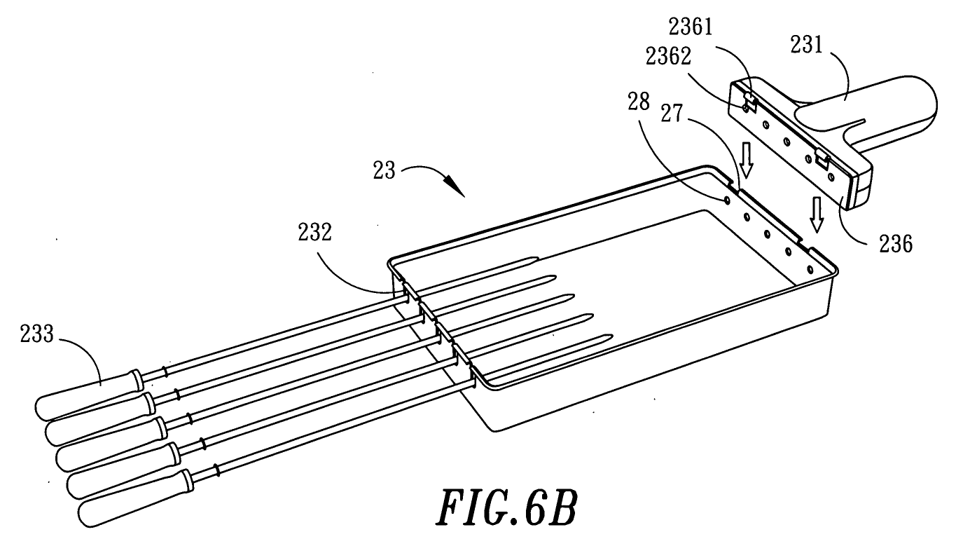

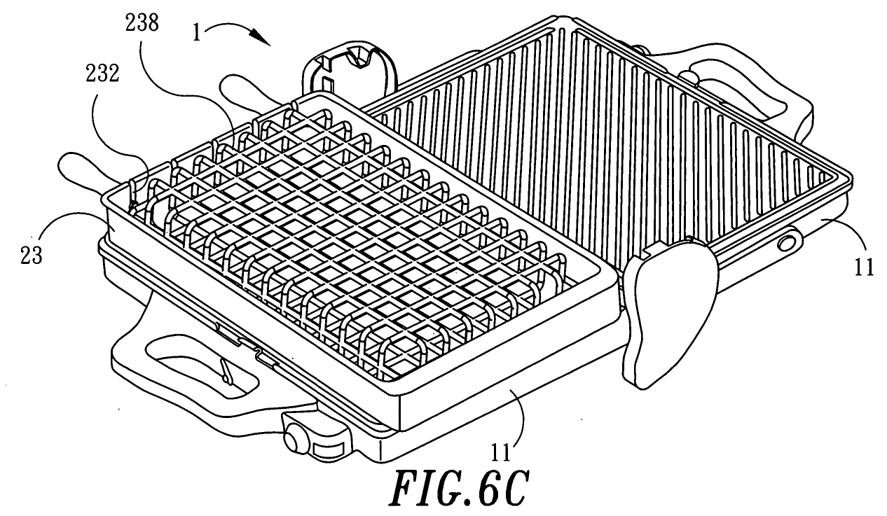

Please refer to FIG. 6. The cooking tool 2 may be a barbecue unit 23. The barbecue unit 23 has a handle 231, a plurality of slots 232 and a plurality of sticks 233.. The slots 232 may hold the sticks 233 in place so that food may be put on these sticks and be cooked. Also, these sticks 233 may be rotated so that food attached to these sticks may be cooked evenly.

Please refer to FIGS. 6A and 6B for the detailed structure of the barbecue unit 23 A motor 234 is disposed inside the handle 231. The output axle of the motor 234 is connected with a set of cogwheels 235. A covering plate 236 is provided. Two fastening pieces 2361 are provided on the covering plate 236 and may connect with two slots provided on a wall of the barbecue unit 23 so as to allow fast assembly and disassembly. A front retaining plate 2351 and a rear retaining plate 2352 are provided. A plurality of cogwheels 2353 may be disposed between the two retaining plates 2351 and 2352. The cogwheels 2353 may mesh with each other or a transmission wheel 2354 may be provided between each pair of the cogwheels. A positioning piece 2355 is provided at the proximal end of each cogwheel 2353, and a positioning hole 2356 is centrally provided on each positioning piece 2355. The row of the positioning holes 2356 may be aligned with a row of holes 2362 provided on the covering plate 236 and a row of holes 28 provided on a wall of the barbecue unit 23 so that the sticks 233 may go through the two rows of holes 28 and 2362 to engage with the positioning holes 2356. Also, the sticks may be rotated by the motor 234. As shown in FIG. 6A, a cylindrical roller 237 may be placed onto each stick 233 with its distal end engaging with the outer perimeter of a corresponding positioning piece 2355. Hence, food may be placed on the rotating rollers 237 (rotated by the motor 234) so as to be cooked evenly.

Please refer to FIG. 6C. A barbecue net unit 238 may be used with the barbecue unit 23. Two handles of the net unit 238 may be inserted into the two slots 232 of the barbecue unit 23 so that the net unit 238 may be held in place. A user may use the two handles 239 to move the net unit 238 around. Food may be placed on the net unit 238 so as to be barbecued.

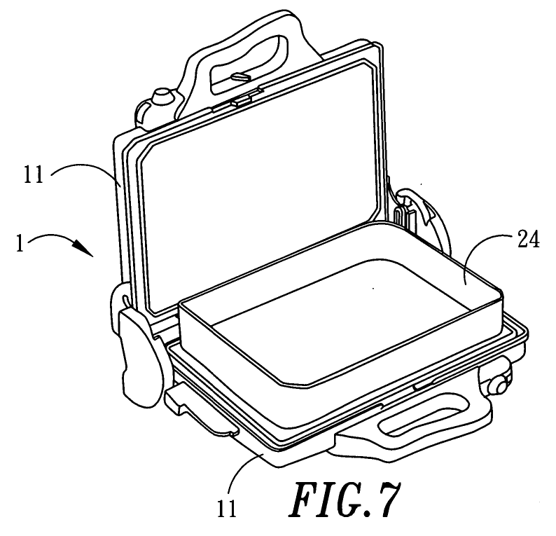

Now, refer to FIG. 7. The cooking tool 2 may be a rectangular cooking pan 24.

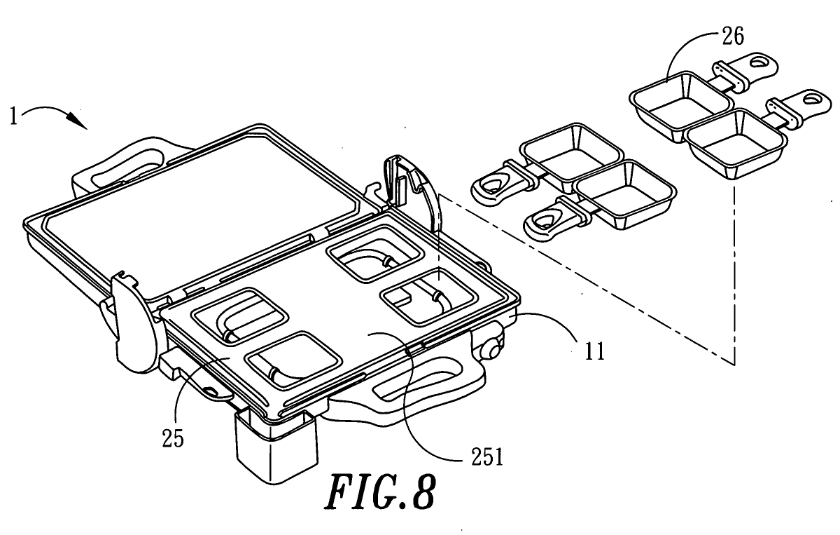

Referring to FIG. 8, the cooking tool 2 may be a plate 25 which has a plurality of rectangular openings 251. A smaller cooking pan 26 may be placed on each opening so that chocolate may be melted in these pans 26. The cooking tool 2 may be of other forms so as to meet other cooking needs.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A portable cooking device, comprising:
a cooking platform, having two symmetrically disposed cooking chambers;
a heating tube disposed in each chamber, providing two pivotal elements between the two chambers and two handles on a top surface of the device so that the device can be folded and be carried around; and
a set of cooking tools, which is placed at an upper portion of either chamber so that food placed on the set of cooking tools is cooked by the heating tube.

2. The portable cooking device as in claim 1, wherein the set of cooking tools is a plate with a top surface of linear pattern so as to be used to cook steaks.

3. The portable cooking device as in claim 1, wherein the set of cooking tools is a plate with a smooth top surface so as to be used to cook beef.

4. The portable cooking device as in claim 1, wherein the set of cooking tools is a rectangular cooking pan.

5. The portable cooking device as in claim 1, wherein the set of cooking tools is a barbecue unit, which has a handle, a plurality of sticks and a plurality of slots provided on a wall of the barbecue unit to hold the sticks in place.

6. The portable cooking device as in claim 5, wherein the handle of the barbecue unit is disassembled and a motor and a set of cogwheels are disposed in the handle so that the sticks are engage with the cogwheels and be rotated around by the motor.

7. The portable cooking device as in claim 5, wherein a cylindrical roller is placed onto each stick.

8. The portable cooking device as in claim 5, wherein a barbecue net unit is used with the barbecue unit and is held in place by two slots of the barbecue unit.

9. The portable cooking device as in claim 1, wherein the set of cooking tools is a plate which has a plurality of rectangular openings and a smaller cooking pan placed on each opening so that chocolate may be melted in these pans.

10. The portable cooking device as in claim 1, wherein a grease collecting pan is fitted at a corner of either chamber and a grease guiding path is provided at the corresponding corner of a cooking tool so that grease generated by the food may flow via the grease guiding path to the grease collecting pan.

11. The portable cooking device as in claim 1, wherein a safety switch is disposed by either heating tube and, in use, after the cooking tool is properly placed on either chamber, a user may then press the safety switch to turn on the device.

12. The portable cooking device as in claim 1, wherein a control knob is provided by either handle and an indicator light is provided by each knob so that a user may use either control knob to turn on and off power and adjust a cooking temperature of the corresponding chamber.
